(19) United States
(12) Patent Application Publication
(10) Pub. No.: US 2023/0184160 A1
(43) Pub. Date: Jun. 15, 2023

(54) IGNITION SYSTEM

(71) Applicant: DENSO CORPORATION, Kariya-city (JP)

(72) Inventors: Yuji KAJI, Kariya-city (JP); Ryo TAMURA, Kariya-city (JP); Yasuomi IMANAKA, Kariya-city (JP); Yuuta KAWASHIMA, Kariya-city (JP); Atsushi IWAMI, Kariya-city (JP); Tatsuya OKA, Kariya-city (JP)

(21) Appl. No.: 18/105,561

(22) Filed: Feb. 3, 2023

Related U.S. Application Data
(63) Continuation of application No. PCT/JP2021/025838, filed on Jul. 8, 2021.

(30) Foreign Application Priority Data
Aug. 7, 2020 (JP) 2020-134723

(51) Int. Cl. F02B 19/12; F02P 5/15; F02B 19/18

(52) U.S. Cl. CPC F02B 19/12; F02P 5/1502; F02B 19/18

(57) ABSTRACT

An ignition system includes a dividing wall which divides a combustion chamber of an engine into a main chamber and a pre-chamber and has formed therein at least one spray hole which communicates between the main chamber and the pre-chamber, and a spark plug in which voltage is applied across a spark gap between a first electrode and a second electrode to create an electrical spark to ignite fuel. The pre-chamber has the first electrode. The dividing wall or a member which electrically conducts with the dividing wall has the second electrode. The ignition system executes an after-top-dead-center ignition control mode to ignite fuel after a compression stroke top dead center. In the after-top-dead-center ignition control mode, an ignition source which is in the form of a self-growable flame kernel is provided in a spray hole-nearby region, the spray hole, or the main chamber within a crank angle of 20° after an ignition timing at which the voltage starts to be applied across the spark gap. The spray hole-nearby region is a region which is located 3 mm or less away from a spray hole center in the pre-chamber.

### CROSS REFERENCE TO RELATED DOCUMENT

The present application claims the benefit of priority of Japanese Patent Application No. 2020-134723 filed on Aug. 7, 2020, the disclosure of which is incorporated in its entirety herein by reference.

### TECHNICAL FIELD

This disclosure relates generally to an ignition system which works to ignite fuel in a combustion chamber.

### BACKGROUND ART

Some ignition systems are equipped with a dividing wall and a spark plug. The dividing wall isolates between a main chamber and a pre-chamber in a combustion chamber of an engine. The dividing wall has formed therein a plurality of spray holes communicating the main chamber with the pre-chamber. The spark plug works to create an electrical spark to ignite fuel upon application of voltage across a spark gap within the pre-chamber. Such a type of spark plug is taught in the following patent literature 1.

### PRIOR ART DOCUMENT

### Patent Literature

Patent Literature 1: Japanese Patent No. 5122367

### SUMMARY OF THE INVENTION

The above type of ignition system works to perform a before-top-dead-center ignition task to ignite fuel before the top dead center of the compression stroke, in other words, during the compression stroke in the engine in a normal operation mode. The before-top-dead-center ignition task is to elongate a spark, as created in the pre-chamber, by means of tumble or swirl occurring in the combustion chamber. The elongated spark then ignites fuel to produce a flame which, in turn, jets into the main chamber, thereby facilitating the combustion of the fuel within the combustion chamber.

When a given condition is encountered, the ignition system alternatively performs an after-top-dead-center ignition task to ignite fuel in the expansion stroke after the top dead center of the compression stroke, i.e., during the expansion stroke. Specifically, for instance, in a first idling mode of the engine operation to warm up the catalyst installed in an exhaust path of the engine, the ignition system starts the ignition of fuel as late as possible in order to enhance the efficiency in transmitting thermal energy, as generated by the combustion of fuel, to the catalyst. The ignition system, therefore, ignites the fuel after the top dead center of the compression stroke.

After the top dead center of the compression stroke, the flow of the mixture in the pre-chamber is usually reduced in strength due to the breaking of the tumble or swirl when the piston passes through the top dead center of the compression stroke. This will result in a decrease in elongation of the spark, thereby reducing the ease of ignition of the fuel, thereby increasing the length of time in which the fuel is ignited in the pre-chamber, and the flame is jetted from the pre-chamber into the main chamber, in other words, decreasing the speed of propagation of the flame to the main chamber.

This disclosure was made in view of the above problem. It is a principal object to achieve quick propagation of a flame to a main chamber in an after-top-dead-center ignition control mode.

An ignition system in this disclosure comprises a dividing wall and a spark plug. The dividing wall divides a combustion chamber of an engine into a main chamber and a pre-chamber. The has formed therein at least one spray hole which communicates between the main chamber and the pre-chamber. The spark plug works to create a spark by applying voltage across a spark gap between a first electrode and a second electrode to ignite fuel. The pre-chamber has the first electrode. The dividing wall or a member which electrically conducts with the dividing wall has the second electrode.

In the following discussion, the timing when the voltage starts to be applied across the spark gap will be referred to as an ignition timing. The center of an opening of the spray hole which is located close to the pre-chamber will be referred to as a spray hole center. A region which is located 3 mm or less away from the spray hole center within the pre-chamber will be referred to as a spray hole-nearby region.

The ignition system works to execute an after-top-dead-center ignition control mode in which an ignition operation to ignite the fuel is performed after a compression stroke top dead center is reached when a given operating condition of the engine is met. In the after-top-dead-center ignition control mode, an ignition source is provided in the form of a self-growable flame kernel within the spray hole-nearby region, the spray hole, or the main chamber within a crank angle of 20° after the ignition timing is reached.

This disclosure offers the following beneficial advantages. In the after-top-dead-center ignition control mode, the ignition source is provided in the spray hole-nearby region, the spray hole, or the main chamber early, e.g., within a crank angle of 20° following the ignition timing. When the ignition source is provided in the spray hole-nearby region or the spray hole, it facilitates the jetting of a flame, as grown from the ignition source, from the spray hole into the main chamber. Alternatively, when the ignition source is provided in the main chamber, it will cause a flame grown from the ignition source to propagate as it is to the main chamber. It is, therefore, possible to propagate the flame quickly to the main chamber in the after-top-dead-center ignition control mode.

### BRIEF DESCRIPTION OF THE DRAWINGS

The present disclosure will be understood more fully from the detailed description given hereinbelow and from the accompanying drawings of the preferred embodiments of the invention.

In the drawings:

FIG. 1 is a sectional view which illustrates an ignition system according to the first embodiment;

FIG. 2 is a sectional view which illustrates a prechamber and a region around the prechamber;

FIG. 3 is a graph which represents a relation between a distance between an ignition source and a spray hole center and a coefficient of variation;

FIG. 4 is a graph which represents growth of a flame kernel;

FIG. 5 is a graph which represents a change in pressure in a combustion chamber;

FIG. 6 is a flowchart of a production method for an ignition system;

FIG. 7 is a graph which represents a relation among a spray hole distance, a spray hole ratio, and an in-gap gas flow;

FIGS. 8(a), 8(b), 8(c), and 8(d) are sectional views which illustrate a spark plug and a region around the spark plug in an embodiment and spark plugs and regions around the spark plugs in comparative examples;

FIG. 9 is a timing chart which demonstrates development of fuel combustion in comparative examples and an embodiment;

FIG. 10 is a view which illustrates the timing chart in FIG. 9 in which ignition timings are shifted to coincide with each other;

FIG. 11 is a graph which demonstrates transitions in combustion percentage in comparative examples and an embodiment;

FIG. 12 is a graph which illustrates an enlarged portion of FIG. 9; and

FIG. 13 is a graph which illustrates changes in gap flow rate in comparative examples and an embodiment.

### MODE FOR CARRYING OUT THE INVENTION

An embodiment in this disclosure will be described below with reference to the drawings. This disclosure is, however, not limited to this embodiment, but may be modified in various ways without departing from the principle of this disclosure.

### First Embodiment

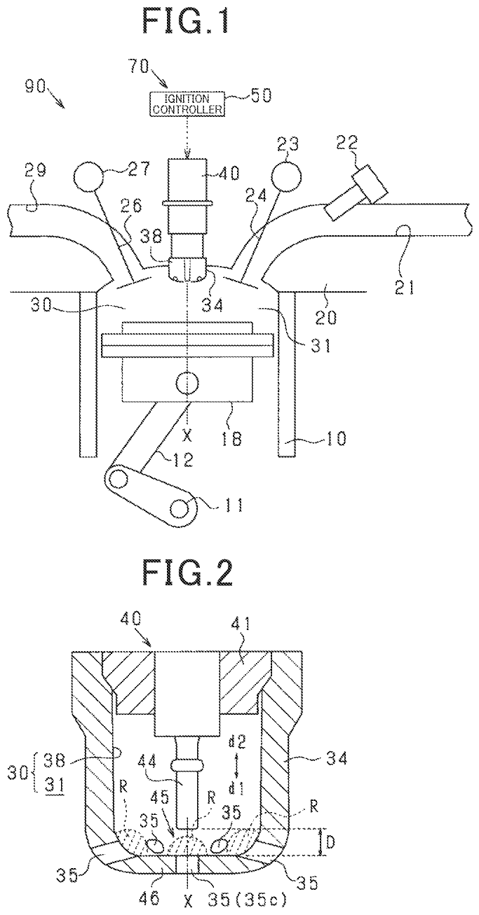

FIG. 1 is a cross sectional view which illustrates the engine 90 on which the ignition system 70 in this embodiment is mounted. The engine 90 is implemented by a four-stroke engine in which a piston completes one combustion cycle made up of a sequence of four separate strokes (i.e., 720° crank angle): intake stroke, compression stroke, expansion stroke, and exhaust stroke. In the following discussion, a top dead center between the compression stroke and the expansion stroke will be referred to as a compression stroke top dead center Td. The engine 90 includes the cylinder 10 and the head 20 mounted on the cylinder 10.

In the following discussion, a lengthwise direction of the center line X of the cylinder 10 illustrated in the drawings will be referred to as a vertical direction. The engine 90 and/or the ignition system 70 may be optionally oriented in various directions. For instance, the engine 90 and/or the ignition system 70 may be oriented to have the center line X which extends obliquely to the vertical direction or alternatively extends the horizontal direction.

The cylinder 10 has the piston 18 disposed therein. The piston 18 is connected to the crankshaft 11 through the link 12 and reciprocates vertically following rotation of the crankshaft 11. Space surrounded by an upper surface of the piston 18, an inner peripheral surface of the cylinder 10, and a lower surface of the head 20 defines the combustion chamber 30.

The head 20 has formed therein the intake path 21 through which air is inducted into the combustion chamber 30 and the exhaust path 29 from which gas discharged from the combustion chamber 30. The intake path 21 has the intake valve 24 installed therein. The exhaust path 29 has the exhaust valve 26 installed therein. The intake valve 24 is driven by the intake cam 23, while the exhaust valve 26 is driven by the exhaust cam 27. The head 20 has the fuel injector 22 mounted in the intake path 21. The fuel injector 23 works to spray fuel.

The ignition system 70 is equipped with the dividing wall 34, the spark plug 40, and the ignition controller 50. The ignition controller 50 is implemented by a portion of an electronic control unit (ECU) and works to analyze information derived by sensors installed in the engine 90 to control an operation of the spark plug 40. The sensors include, for example, a crank angle sensor, a knock sensor, an intake pressure sensor, an exhaust pressure sensor, an in-cylinder pressure sensor, and a catalyst temperature sensor.

FIG. 2 is a cross sectional view which illustrates the pre-chamber 38 and a region therearound. The spark plug 40 includes the first electrode 44 and the porcelain insulator 41 disposed around the outer periphery of the first electrode 44. The dividing wall 34 is secured to a lower end portion of the porcelain insulator 41. The dividing wall 34 defines the pre-chamber 38 and the main chamber 31. The pre-chamber 38 is located inside the diving wall 34. The main chamber 31 is located outside the dividing wall 34. In other words, the dividing wall 34 isolates the combustion chamber 30 of the engine 90 into the main chamber 31 and the pre-chamber 38. The dividing wall 34 has formed therein a plurality of spray holes 35 communicating between the main chamber 31 and the pre-chamber 38. The dividing wall 34 is made from an electrically conductive material and functions as the second electrode 46 of the spark plug 40. The spark plug 40 is subjected to application of voltage across the spark gap 45 between the first electrode 44 and the second electrode 46 to create an electric spark f which ignites the fuel.

More specifically, the spark plug 40 is equipped with a primary coil and a secondary coil. By applying an electrical current to the primary coil, electromagnetic energy is charged in the primary coil. Subsequently, stopping the application of current will cause the electromagnetic energy stored in the primary coil to induce voltage at the secondary coil. The induced voltage is then applied to the spark gap 45 to create the spark f within the spark gap 45. The time when the application of current to the primary coil is stopped will, therefore, coincide with an ignition timing Ts when the voltage starts to be applied across the spark gap 45 to initiate ignition of fuel.

In the following discussion, one of the spray holes 35 which lies on the center line X of the cylinder 10 will also be referred to as the center spray hole 35c. The center spray hole 35c extends vertically through the thickness of the dividing wall 34. The first electrode 44 has a lower end located just above the center spray hole 35c. In other words, the lower portion of the first electrode 44 protrudes greatly downward from the lower end the porcelain insulator 41, so that it is located closest to the center spray hole 35c among the spray holes 35. The gap between the lower end of the first electrode 44 and an upper periphery of the center spray hole 35c in the dividing wall 34 defines the spark gap 45. The spray holes 35 other than the center spray hole 35c are arranged around the center spray hole 35c in the dividing wall 34. The center spray hole 35c and the other spray holes 35 may be designed to be identical or different in sectional area or configuration with or from each other.

In a normal mode of operation, the ignition system 70 executes a before-top-dead-center ignition control mode to ignite fuel before the compression stroke top dead center Td. Alternatively, when a given operating condition of the engine 90, e.g., a fast idling mode of operation to warm up a catalyst installed in the exhaust path 29, is entered, the ignition system 70 executes an after-top dead center ignition control mode to ignite fuel after the compression stroke top dead center Td.

In the following discussion, a gas flow passing through the spark gap 45 will also be referred to as an in-gap gas flow. A direction from the first electrode 44 toward the center spray hole 35c will also be referred to as a spray hole direction d1. A direction opposite to the spray hole direction d1 will also be referred to as a spray hole opposite direction d2. In this embodiment, the spray hole direction d1 represents a downward direction. The spray hole opposite direction d2 represents an upward direction. A direction including the spray hole direction d1 as a component will also be referred to below as a spray hole direction d1-side or merely referred to as the spray hole direction d1. A direction including the spray hole opposite direction d2 as a component will also be referred to as a spray hole opposite direction d2-side or merely referred to as the spray hole direction d2.

After the after-top-dead-center ignition control mode is entered, in the ignition system 70, the in-gap gas flow is changed from the spray hole opposite direction d2-side to the spray hole direction d1-side until the ignition timing Ts is reached. At the ignition timing Ts, the in-gap gas flow is, therefore, oriented to the spray hole direction d1-side, thereby causing the spark f to be elongated toward the spray hole direction d1-side.

In the following discussion, the center of an opening of the center spray hole 35c which is exposed to the pre-chamber 38 will be also referred to below as a spray hole center. A region located within the pre-chamber 38 at an interval of 3 mm or less away from the spray hole will be referred to below as a spray hole-nearby region R.

When it is required to execute the after-top-dead-center ignition control mode, the ignition system 70 works at an early stage within a crank angle of 20° following the ignition timing Ts to place an ignition source in the form of a flame kernel large in size enough to self-grow in the spray hole-nearby region R, the center spray hole 35c, or the main chamber 31. In the flowing discussion, “in the spray hole-nearby region R, the center spray hole 35c or the main chamber 31” will be generally referred to as “in the spray hole-nearby region R, etc.”.

In this disclosure, “the size of the flame kernel large enough to self-grow” means that the flame kernel which will spread without being extinguished by heat loss or lean mixture in the combustion chamber even when application of voltage to the spark gap 45 is stopped. More specifically, the size of a flame kernel large enough to self-grow refers to a diameter of about 0.5 to 1.0 mm.

The placement of the ignition source within the spray hole-nearby region R, etc. in the early stage is achieved by selecting a spray hole distance D that is a distance between the first electrode 44 and the center spray hole 35c, a prechamber volume V that is a volume of the pre-chamber 38, a total spray hole area S that is the sum of sectional areas of all the spray holes 35 formed in the dividing wall 34, and/or a discharge voltage that is a voltage applied across the spark gap 45. This will be described below in detail. In the case were the spray holes 35 are partially constricted, so that a sectional area of each of the spray holes 35 is ununiform, the smallest sectional area of each of the spray holes 35 will be simply referred to as a sectional area of each of the spray holes 35.

First, the spray hole distance D will be described. The shorter the spray hole distance D, the greater the effects of flows of gas passing through the center spray hole 35c on a flame kernel. This facilitates the growth of the flame kernel, especially, in the spray hole-nearby region R, etc., and its peripheral region. For this reason, the shorter the spray hole distance D, the easier the creation of an ignition source in the spray hole-nearby region R, etc., in the early stage.

Next, the prechamber volume V and the total spray hole area S will be described in detail. The more the prechamber volume V, the faster a flow of gas moving through the center hole 35c in the after-top-dead-center ignition control mode. This is because the larger the prechamber volume V, the more slowly the pressure in the pre-chamber 38 drops following a drop in pressure in the main chamber 31 as long as the flow rate of gas moving out of the pre-chamber 38 into the main chamber 31 is kept constant, thereby resulting in an increased difference in pressure between the pre-chamber 38 and the main chamber 31, which increases the velocity of gas passing through the center spray hole 35c.

The smaller the total spray hole area S, the faster the velocity of gas flowing through the center spray hole 35c will be in the after-top-dead-center ignition control mode. This is because as long as the prechamber volume V remains unchanged, the smaller the total spray hole area S, the smaller the flow rate of gas moving out of the pre-chamber 38 into the main chamber 31 will be, thereby causing a drop in pressure in the pre-chamber 38 to become slow following a drop in pressure in the main chamber 31. This results in an increased difference in pressure between the pre-chamber 38 and the main chamber 31, which increases the velocity of gas passing through the center spray hole 35c.

The increase in velocity of gas passing through the center spray hole 35c will facilitate the elongation of the spark f to the spray hole direction d1-side. This facilitates the growth of a flame kernel in the early stage, especially, in the spray hole-nearby region R, etc. and its peripheral region. When it comes to the prechamber volume V and the total spray hole area S, the smaller a spray hole ratio (S/V) that is a ratio of the total spray hole area S to the prechamber volume V, the more easily the ignition source is created in the spray hole-nearby region R, etc. at the early stage.

Next, the discharge voltage will be described below. The higher the discharge voltage, the easier a flame kernel is to grow. Additionally, the higher the discharge voltage, the higher the stability of the flame kernel, thereby facilitating the ease with which the spark f is elongated by the gas flow into the spray hole-nearby region R, etc. or its peripheral region. Consequently, the higher the discharge voltage, the more easily the ignition source is created in the spray hole-nearby region R, etc. at the early stage.

As apparent from the above discussion, the smaller the spray hole distance D or the spray hole ratio (S/V) or the higher the discharge voltage, the more easily the ignition source is created in the spray hole-nearby region R, etc. at the early stage. Too small the spray hole distance D or the spray hole ratio (S/V) or too high the discharge voltage will, however, result in another adverse effect. In this embodiment, the early creation of the ignition source in the spray hole-nearby region R, etc. is achieved by decreasing the spray hole distance D or the spray hole ratio (S/V) and/or increasing the discharge voltage to an extent that no above adverse effect occurs.

The creation of an ignition source in the spray hole-nearby region R or the spray holes 35 usually causes a flame grown from the ignition source to be quickly jetted into the main chamber 31. The creation of an ignition source within the main chamber 31 causes a flame grown from the ignition source to propagate directly into the main chamber 31. Such cases achieve the quick propagation of a flame into the main chamber 31.

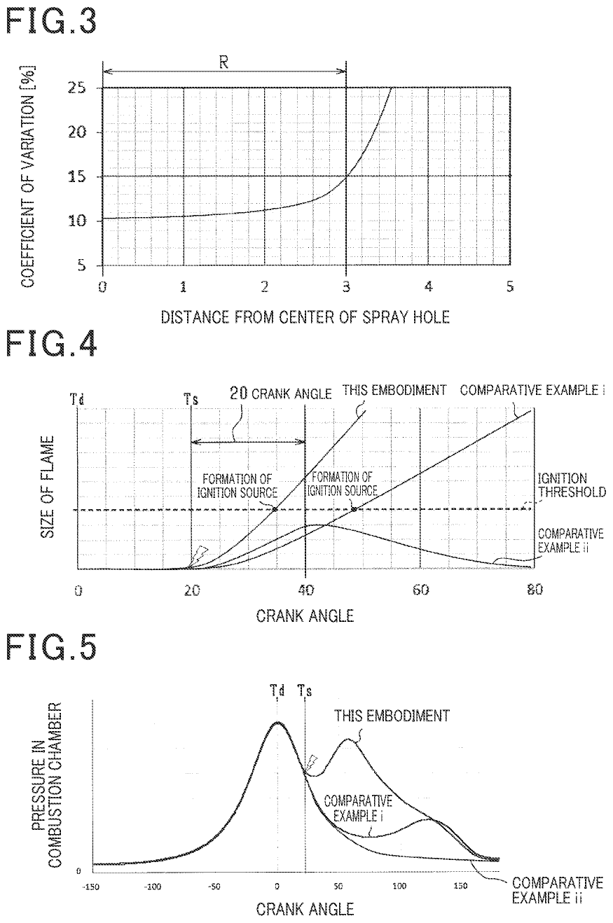

FIG. 3 is a graph which represents a relation between the distance between an ignition source and the spray hole center and a combustion stability index (which will also be referred to below as a coefficient of variation). The coefficient of variation is an index indicating a degree of fuel combustion in a range of the lowest stability of combustion of fuel, i.e., a misfire to the highest stability of combustion of fuel, i.e., complete combustion of fuel. The higher value of the coefficient of variation represents the higher stability of combustion of fuel. The graph in FIG. 3 shows that the greater the distance between the ignition source and the spray hole center, the greater the coefficient of variation will be and that when the ignition source is located 3 mm or more away from the spray hole center, the coefficient of variation will become large at an increased rate. In view of such a relation between the coefficient of variation and the distance between the ignition source and the spray hole center, the ignition source is arranged in the spray hole-nearby region R which lies 3 mm or less away from the spray hole center.

FIG. 4 is a graph which represents the growth of a flame kernel and shows that this embodiment achieves faster growth of a flame kernel than in comparative examples i and ii and also that the propagation of a flame is faster in this embodiment than in the comparative examples i and ii. It is also found that when a flame kernel, like in this embodiment and the comparative example i, has grown up to a given ignition threshold, it will be enabled to grow by itself and spread, while when a flame kernel, like in the comparative example ii, has not grown to the ignition threshold, it will have difficulty growing by itself, so that the flame disappears.

FIG. 5 is a graph which demonstrates a change in pressure in the combustion chamber and shows that the pressure raises with advance of the crank angle before the compression stroke top dead center Td and then drops with advance of the crank angle after the compression stroke top dead center Td in each of this embodiment and the comparative examples i and ii. The graph also shows that upon ignition, the pressure will rise again in this embodiment and the comparative example i. The flame kernel grows faster in this embodiment than in the comparative example i, and the propagation of the flame is faster in this embodiment than in the comparative example i, thereby causing the pressure in the combustion chamber to elevate quickly in this embodiment. Conversely, when the flame burns out, like in the comparative example, it will cause the pressure in the combustion chamber not to rise.

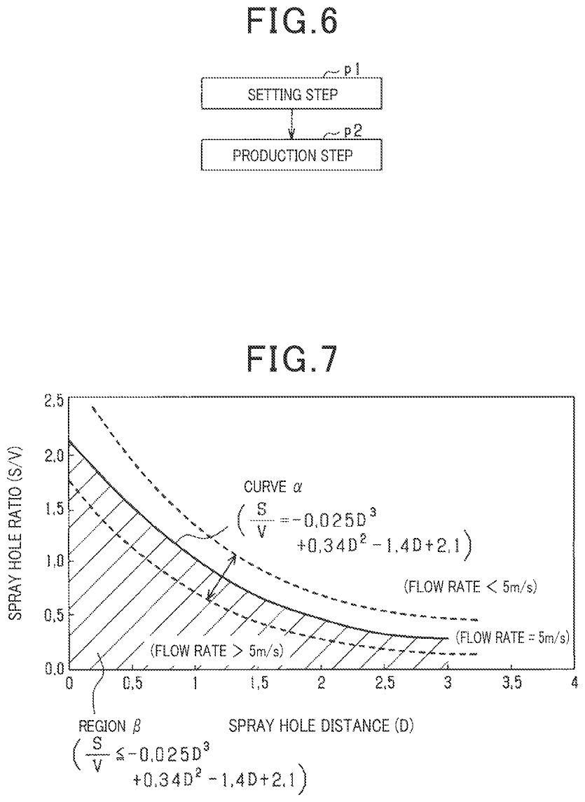

FIG. 6 is a view which shows a flowchart of a sequence of steps in a production process for the ignition system 70. The production process incudes a setting step p1 and a production step p2.

In the setting step p1, a spray hole ratio (S/V) is calculated. The dimensions of the pre-chamber 38 and the spray holes 35 are determined as a function of the spray hole ratio (S/V) and the spray hole distance D. The setting step p1 will also be described below in detail with reference to FIG. 7. Next, in the production step p2, the ignition system 70 is produced to have the dimensions set in the setting step p1.

FIG. 7 is a graph which represents a relation among the spray hole distance, the spray hole ratio, and the in-gap gas flow. The horizontal axis indicates the spray hole distance D. The vertical axis indicates the spray hole ratio (S/V). The curve a represents a relation between the spray hole ratio (S/V) and the spray hole distance D when the in-gap gas flow in the spray hole direction d1 is 5 m/s at the ignition timing in the after-top-dead-center ignition control mode. The curve a may be mathematically expressed using the following approximation formula A.

S/V=−0.025D\hat{ }3+0.34D\hat{ }2−1.4D+2.1 Eq. A

where V denotes the prechamber volume V [cc (cubic centimeter)], S denotes the total spray hole area (i.e., a total sectional area of the spray holes 35) [mm\hat{ }2], D denotes the spray hole distance D [mm], and “\hat{ }” represents a power. Note that “\hat{ }3” is a cube, and “\hat{ }2” represents a square.

On the upper side above the curve a, the in-gap gas flow at the ignition timing Ts in the after-top-dead-center ignition control mode is lower than 5 m/s in the spray hole direction d1, while on the lower side below the curve a, the in-gap gas flow at the ignition timing Ts in the after-top-dead-center ignition control mode is higher than 5 m/s in the spray hole direction d1.

In this embodiment, in order to have the in-gap gas flow in the spray hole direction d1 which is higher than or equal to 5 m/s at the ignition timing Ts in the after-top-dead-center ignition control mode, the value of the spray hole ratio (S/V) is selected in a region 3 including the curve a and the lower side below the curve a. In other words, the value of the spray hole ratio (S/V) is determined to meet the following Eq. B which is equivalent to Eq. A in which “=” is replaced by “≤”.

S/V≤−0.025D\hat{ }3+0.34D\hat{ }2−1.4D+2.1 Eq. B

Eq. B sets the in-gap gas flow in the spray hole direction d1 to be higher than or equal to 5 m/s at the ignition timing Ts in the after-top-dead-center ignition control mode.

The curve a usually changes with a change in environment. For instance, when the speed of rotation of the engine 90 becomes high, the quantity of intake air increases, or the engine 90 is implemented by a high-compression engine, the curve a will be shifted to an upper right-hand side in FIG. 7. Alternatively, when the speed of rotation of the engine 90 becomes low, the quantity of intake air decreases, or the engine 90 is implemented by a low-compression engine, the curve a will be shifted to a lower left-hand side in FIG. 7. In such a case, it is advisable that Eq. B be corrected as needed.

However, in the absence of the above correction, the acceptable in-gap gas flow is expected to be obtained at the ignition timing Ts in the after-top-dead-center ignition control mode during the fast idle mode of engine operation in which the speed of the engine, the quantity of intake air, and the compression ratio are normal.

However, when the spray hole ratio (S/V) is lower than 0.3, it causes a risk that too strong a gas flow may pass through the spray holes 35, so that the flame is blown away. It is, therefore, preferable that the spray hole ratio (S/V) be selected to be 0.3 or more. When the spray hole distance D is zero in Eq. B, the right side will be 2.1. Satisfying Eq. B, therefore, requires selecting the value of the spray hole ratio (S/V) to be 2.1 or less. Consequently, the value of the spray hole ratio (S/V) is determined to meet the following Eq. C in addition to Eq. B.

0.3≤S/V≤2.1 Eq. C

More specifically, it is advisable that the diameter of each of the spray holes 35 be selected to be 0.3 mm or more in order to eliminate a risk that a flame passing through each of the spray holes 35 may disappear due to thermal loss thereof. It is also advisable that the prechamber volume V be selected to be 0.2 cc or more in order to ensure an amount of gas jetting from the prechamber 38 (i.e., the quantity of heat) large enough to enhance the propagation of a flame within the main chamber 31.

The spray hole distance D is preferably selected in light of blowing out of the spark f or the amount of electrical power consumed by the spark plug 40 as a function of the size of the spark gap 45 because the spray hole distance D impinges on the size of the spark gap 45. The area of a cross section of the center spray hole 35c is also preferably selected in light of adverse effects thereof on the spark gap 45. The spray hole ratio (S/V) is preferably determined by selecting cross-sectional areas of the spray holes 35 other than the center spray hole 35c.

In the setting step p1 in FIG. 6, the spray hole ratio (S/V) is set in the above way. Physical parameters of the spark plug 40 other than the spray hole ratio (S/V) may be determined in a known manner. In the production step p2, the ignition system 70 are made to meet the dimensions or parameters determined in step p1 to complete the ignition system 70.

The functions of the ignition system 70 in this embodiment will be described below.

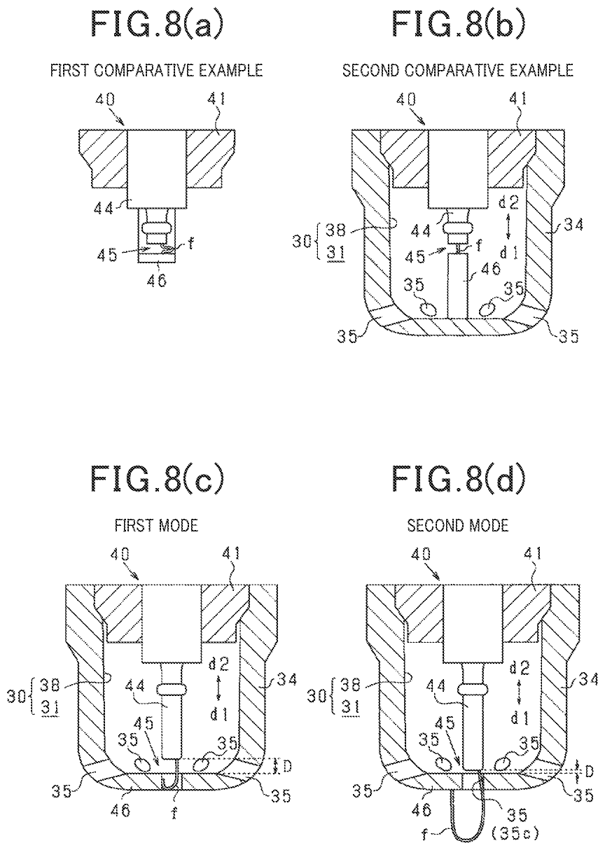

FIG. 8(a) is a sectional view which illustrates the ignition system 70 in the first comparative example which is different from this embodiment in that there is no dividing wall 34, but the second electrode 46 (i.e., ground electrode) is arranged alone. FIG. 8(b) is a sectional view which illustrates the ignition system 70 in the second comparative example which is different from the first comparative example in that it includes the dividing wall 34, but does not have the center spray hole 35c. The first electrode 44 does not protrude downward more than in this embodiment, but instead the second electrode 46 (i.e., ground electrode), unlike this embodiment, protrude greatly from the dividing wall 34 toward the first electrode 44 (i.e., center electrode). The second comparative example is designed not to meet the above Eq. B. In the second comparative example which, as described above, does not have the center spray hole 35c, the center of gravity of the spray holes 35 located closest to each other lies beneath the spark gap 45. The downward direction in the second comparative example will be, therefore, referred to, like this embodiment, as the spray hole direction d1, while the upward direction will be referred to as the spray hole opposite direction d2.

FIG. 8(c) is a sectional view which illustrates the ignition system 70 in the first mode of this embodiment. FIG. 8(d) is a sectional view which illustrates the ignition system 70 in the second mode of this embodiment. The spray hole ratio (S/V) or the spray hole distance D in the first mode is smaller than that in the second mode. The spray hole distance D in FIG. 8(d) is shorter than that in FIG. 8(c), thereby causing the in-gap gas flow in the spray hole direction d1 to be greater in the second mode than in the first mode at the ignition timing Ts in the after-top-dead-center ignition control mode. Consequently, an initial ignition source is generated in the pre-chamber 38 and/or the center spray hole 35c in the first mode, while it is created in the pre-chamber 38, the center spray hole 35c, and/or the main chamber 31 in the second mode.

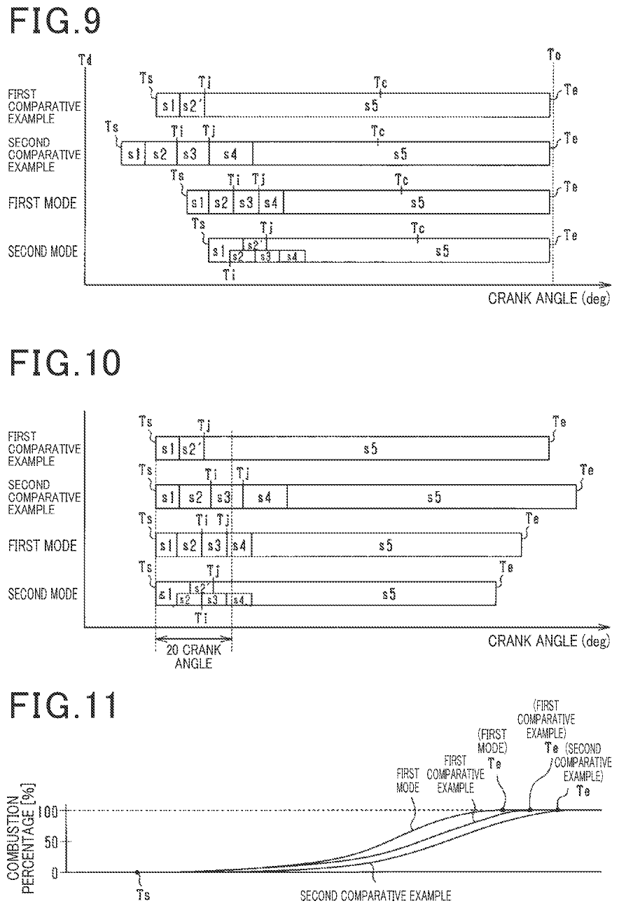

FIG. 9 is a timing chart which demonstrates the development of combustion of fuel in the after-top-dead-center ignition control mode in the first and second comparative examples. In the first comparative example, the combustion of fuel proceeds from the spark phase s1, to the main chamber ignition phase s2′, and then to the main chamber flame propagation phase s5. The beginning of the spark phase s1 occurs at the ignition timing Ts. The spark phase s1 is a phase in which the voltage has started to be applied across the spark gap 45, but a flame kernel is not yet generated in the combustion chamber 30.

The main chamber ignition phase s2′ is a phase in which a flame kernel is growing to a self-growable ignition source within the main chamber. The end of the main chamber ignition phase s2′ coincides with the main chamber ignition timing Tj that is the timing when an ignition source is created within the main chamber 31. The main chamber flame propagation phase s5 is a phase in which the ignition source is propagating to the main chamber 31. The end of the main chamber flame propagation phase s5 coincides with the combustion end timing Te when the fuel is expected to have been burned completely.

In the second comparative example and the first mode, the combustion of fuel proceeds from the spark phase s1 to the pre-chamber ignition phase s2, to the pre-chamber flame propagation phase s3, to the gas jetting phase s4, and then to the main chamber flame propagation phase s5. The pre-chamber ignition phase s2 is a phase in which a flame kernel is growing to a self-growable ignition source in the pre-chamber. The end of the pre-chamber ignition phase s2 coincides with the pre-chamber ignition timing Ti that is the timing when the ignition source is created in the pre-chamber 38.

The pre-chamber flame propagation phase s3 is a phase in which the ignition source is propagating to the pre-chamber 38. The flame jetting phase s4 is a phase in which a flame in the pre-chamber 38, that is, an ignition source is jetting from each of the spray holes 35 into the main chamber 31. The beginning of the flame jetting phase s4 coincides with the main chamber ignition timing Tj that is the timing when the ignition source is placed in the main chamber 31.

In the second mode, the spark f extends from inside the pre-chamber 38 into the main chamber 31 through the center spray hole 35c, thereby causing ignition sources to be created by the spark f within the main chamber 31 as well as the pre-chamber 38 and the center spray hole 35c. Consequently, like in the first mode, the combustion of fuel proceeds from the spark phase s1, to the main chamber ignition phase s2′, and then to the main chamber flame propagation phase s5 in parallel to a series of ignition source development from the spark phase s1, to the pre-chamber ignition phase s2, to the pre-chamber flame propagation phase s3, to the flame jetting phase s4, and then the main chamber flame propagation phase s5. This causes the main chamber ignition timing Tj to appear earlier than in the first mode.

In each of the first and second comparative examples and each of the first and second modes, the combustion end timing Te is required to be earlier than the exhaust start time To that is the time when the exhaust valve 26 starts to open in order to avoid emission of unburned fuel. Accordingly, in any case, the combustion end timing Te is first determined prior to the exhaust start time To. Subsequently, the ignition timing Ts is determined to have fuel completely combusted at the combustion end timing Te. In other words, the ignition timing Ts is calculated back from the combustion end timing Te. Therefore, the combustion end timings Te almost coincide with each other in the first and second comparative examples and the first and second modes, while the ignition timings Ts are different from each other.

FIG. 10 is a graph which demonstrates the timing chart illustrated in FIG. 9 where the ignition timings Ts in the first and second comparative examples and the first and second modes are altered to coincide with each other for the sake of convenience. In the second comparative example, the spark gap 45 is located away from the spray holes 35, so that the ignition source is arranged within the spray hole-nearby region R near the end of the pre-chamber flame propagation phase s3. The end of the pre-chamber flame propagation phase s3 in the second comparative example substantially coincides with a time, a crank angle of 20° or more after the ignition timing Ts. In the second comparative example, the ignition source is arranged within the spray hole-nearby region R at a time, a crank angle of 20° or more after the ignition timing Ts. This causes the main chamber ignition timing Tj to retard, so that the development of combustion of fuel becomes slower than that in the first comparative example which does not include the pre-chamber 38.

In the first mode of this embodiment, the spark gap 45 is located closer to the center spray hole 35c, thereby causing the time when the ignition source appears in the spray hole-nearby region R to lie in the first half of the pre-chamber flame propagation phase s3. The first half of the pre-chamber flame propagation phase s3 in the first mode lies within a crank angle of 20° after the ignition timing Ts. The ignition source, therefore, appears in the spray hole-nearby region R within a crank angle of 20° after the ignition timing Ts. This results in smaller delay in the main chamber ignition timing Tj than in the first comparative example, so that the development of combustion of fuel becomes faster than that in the first comparative example which does not include the pre-chamber 38.

In the second mode of this embodiment, the time when the ignition source is created by the spark f within the main chamber 31 coincides with the main chamber ignition timing Tj corresponding to the end of the main chamber ignition phase s2′. The main chamber ignition timing Tj in the second mode lies within a crank angle of 20° after the ignition timing Ts. This causes the ignition source to appear in the main chamber 31 within a crank angle of 20° after the ignition timing Ts, so that the development of combustion of fuel becomes faster than in the first mode.

FIG. 11 is a graph which demonstrates transitions in combustion percentage in the first and second comparative examples, and the first mode of this embodiment. In the second comparative example, the percentage of combustion of fuel, as described above, changes more slowly than in the first comparative example which does not include the pre-chamber 38, while it changes in the first mode of this embodiment faster than in the first comparative example.

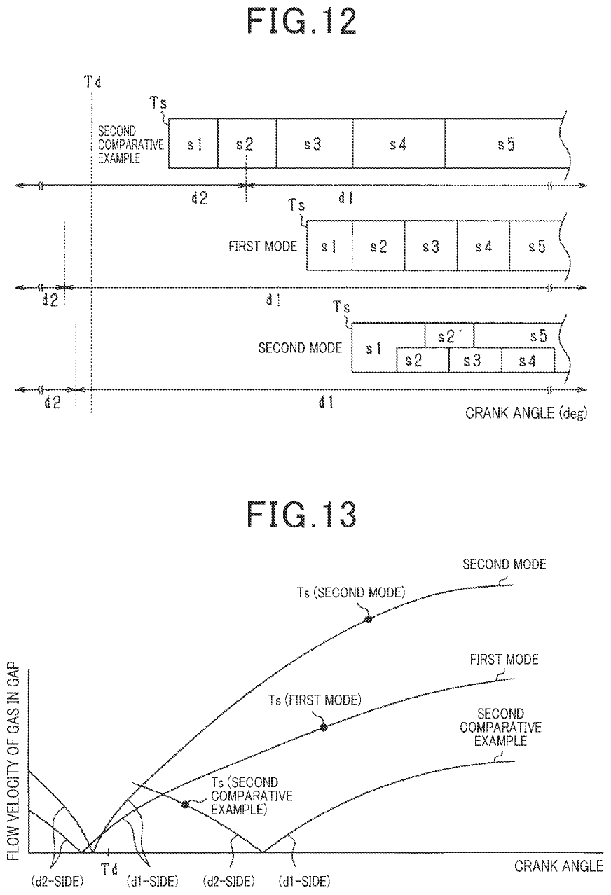

FIG. 12 is a graph which illustrates an enlarged portion of FIG. 9. FIG. 13 is a graph which demonstrates transitions in the in-gap gas flow in a period illustrated in FIG. 13 in the second comparative example and the first and second modes of this embodiment. In the second comparative example, the in-gap gas flow is still oriented in the spray hole opposite direction d2 at the ignition timing Ts in the after-top-dead-center ignition control mode. This is because the in-gap gas flow is kept oriented by inertia thereof in the spray hole opposite direction d2 in a deep portion of the pre-chamber 38 for a while after the compression stroke top dead center Td is passed. Subsequently, the strength of the in-gap gas flow temporarily becomes zero, after which the direction of the in-gap gas flow turns in the spray hole direction d1. The gas flow in such a period of time is, therefore, very weak, so that the spark f does not extend sufficiently, thus facing a risk of failure in igniting the fuel.

In the first and second modes of this embodiment, the in-gap gas flow, as described above, has already turned from the spray hole opposite direction d2 to the spray hole direction d1 before the ignition timing Ts in the after-top-dead-center ignition control mode. This causes a strong flow of gas to be created, for example, at 5 m/s or more in the spray hole direction d1 at the ignition timing Ts, thereby facilitating extension of the spark f in the spray hole direction d1, which enhances the growth of a flame kernel in or around the spray hole-nearby region R. Consequently, the first and second modes of this embodiment are capable of creating the ignition source quickly within the spray hole-nearby region R.

Referring back to FIG. 9, the combustion end timing Te is, as described above, required to be earlier than the exhaust start time To. It is, therefore, impossible to retard the ignition timing Ts sufficiently in the fast idling mode in which the timing of fuel combustion needs to be as late as possible in the first and second comparative examples in which a combustion time period that is an interval between the ignition timing Ts and the combustion end timing Te, thereby resulting in a difficulty in sufficiently retarding the combustion center-of-gravity Tc that is equivalent to a time when 50% of fuel has been combusted, which may lead to a lack in warming the catalyst in the fast idling mode.

In contrast to the above, the first and second modes of this embodiment are capable of shortening the combustion period of time that is an interval between the ignition timing Ts and the combustion end timing Te as compared with the first and second comparative examples, thereby enabling the ignition timing Ts to be retarded sufficiently. This permits the combustion center-of-gravity Tc to be retarded greatly as compared with the first and second comparative examples, thereby ensuring the stability in warning the catalyst in the fast idling mode, which leads to a decreased duration of the fast idling mode to improve the fuel consumption in the engine 90 and reduce exhaust emissions from the engine 90.

This embodiment offers the following beneficial advantages. In the after-top-dead-center ignition control mode, the ignition source is created in the spray hole-nearby region R, the center spray hole 35c, or the main chamber 31 shown in FIG. 2 early, e.g., within a crank angle of 20° following the ignition timing Ts. When the ignition source is arranged in the spray hole-nearby region R or the center spray hole 35c, it facilitates the jetting of a flame, as grown from the ignition source, from the center spray hole 35c into the main chamber 31. Alternatively, when the ignition source is provided in the main chamber 31, it will cause a flame grown from the ignition source to propagate as it is in the main chamber 31. It is, therefore, possible to propagate the flame quickly to or in the main chamber 31 in the after-top-dead-center ignition control mode.

The second mode of this embodiment offers the following beneficial advantages. In the after-top-dead-center ignition control mode in the second mode, the spark f is extended to reach the inside of the main chamber 31, thereby creating the ignition source within the main chamber 31 at an early point within a crank angle of 20° after the ignition timing. The flame, as growing from the ignition source, propagates as it is to the main chamber 31. The second mode, therefore, ensures quick propagation of the flame to the main chamber 31.

Additionally, the dimensions of the pre-chamber 38 and the spray holes 35 are selected to meet the above Eq. B in order to have the spray hole ratio (S/V) falling in the region β illustrated in FIG. 7. The region β is, as described above, a region where the in-gap gas flow at the ignition timing Ts in the after-top-dead-center ignition control mode moves at 5 m/s or more in the spray hole direction d1. The in-gap gas flow which moves at 5 m/s or more in the spray hole direction d1, as already described, serves to facilitate early creation of the ignition source in the spray hole-nearby region R.

The region β depends slightly on the circumferences, but however, is expected to produce a required degree of the in-gap gas flow at the ignition timing Ts in the after-top-dead-center ignition control mode when the engine 90 is operated at a usual speed, with a usual quantity of intake air, and at a usual compression ratio. The quick creation of the ignition source in the spray hole-nearby region R is, therefore, achieved easily by selecting the spray hole ratio (S/V) to lie in the region β.

The second mode also has the following beneficial advantage. When the spray hole ratio (S/V) is less than 0.3, it will, as described above, result in too strong a flow of gas passing through the spray holes 35, thereby undesirably blowing away the flame. This embodiment is, as described above, configured to set the spray hole ratio (S/V) to be 0.3 or more, thus eliminating the above problem.

The second mode also has the following beneficial advantage. The in-gap gas flow, as can be seen in FIG. 13, turns from the spray hole opposite direction d2 (i.e., the spray hole opposite direction d2-side) to the spray hole direction d1 (i.e., the spray hole opposite direction d1-side) until the ignition timing Ts is reached in the after-top-dead-center ignition control mode. This causes the in-gap gas flow to be oriented in the spray hole direction d1 at the ignition timing Ts in the after-top-dead-center ignition control mode, thereby ensuring the stability in extending the spark f in the spray hole direction d1. This facilitates the quick creation of an ignition source within the spray hole-nearby region R.

### Other Embodiments

The above described modes of this embodiment may be modified in the following ways. In the first embodiment, the dividing wall 34 has a plurality of spray holes 35 formed therein, but may alternatively be designed to have only the single center spray 35c. The first embodiment has the first electrode 44 located closest to the center spray hole 35c, but however, may alternatively be designed to arrange the first electrode 44 closest to one(s) of the other spray holes 35 to extend the spark f toward it. The dividing wall 34 in the first embodiment also works as the second electrode 46 and is attached to the head 20 in electrical conduction therewith, but however, it may be configured to have a protrusion(s) which is in electrical conduction to the dividing wall 34 and serves as the second electrode 46. Alternatively, the second electrode 46 may be made of a member which is discrete from the dividing wall 34 and electrically connects with the head 20.

The first embodiment has the dividing wall 34 secured to the porcelain insulator 41 of the spark plug 40, but however, the dividing wall 34 may alternatively be attached to the head 20. Additionally, the spark plug 40 may be arranged to have the porcelain insulator 41 arranged in engagement with the dividing wall 34 of the head 20.

While this disclosure has referred to the embodiments, it should be appreciated that the disclosure is not limited to the embodiments. This disclosure may include a variety of combinations of the embodiments, a combination of diverse modifications of the embodiments and equivalents thereof.

What is claimed is:

1. An ignition system comprising:
a dividing wall which divides a combustion chamber of an engine into a main chamber and a pre-chamber and has formed therein at least one spray hole which communicates between the main chamber and the pre-chamber; and
a spark plug in which voltage is applied across a spark gap between a first electrode and a second electrode to create an electrical spark to ignite fuel, wherein
the pre-chamber has the first electrode,
the dividing wall or a member which is electrically connected to the dividing wall has the second electrode,
an after-top-dead-center ignition control mode in which an ignition operation to ignite the fuel using the spark plug is performed after a compression stroke top dead center is executed when a given operating condition of the engine is met, and
in the after-top-dead-center ignition control mode, an ignition source which is in a form of a self-growable flame kernel is provided in a spray hole-nearby region within the pre-chamber, the spray hole, or the main chamber within a crank angle of 20° after an ignition timing where the ignition timing is a timing when the voltage starts to be applied across the spark gap, and the spray hole-nearby region is a region which is located 3 mm or less away from a spray hole center that is a center of an opening of the spray hole which faces the pre-chamber.

2. The ignition system as set forth in claim 1, wherein in the after-top-dead-center ignition control mode, the spark is extended to reach inside the main chamber to provide the ignition source in the main chamber within a crank angle of 20° after the ignition timing.

3. The ignition system as set forth in claim 1, wherein a gas flow passes through the spark gap at a speed of 5 m/s or more in a period of time in which the spark is created in the after-top-dead-center ignition control mode.

4. The ignition system as set forth in claim 1, wherein a relation of S/V≤−0.025D\hat{ }3+0.34D\hat{ }2−1.4D+2.1 is met where V is a volume of the pre-chamber in units of cubic centimeter, S is a total sectional area of the spray hole in the dividing wall in units of mm\hat{ }2, and D is a distance between the first electrode and the spray hole in units of mm or when the dividing wall has a plurality of spray holes formed therein, D denotes a distance between the first electrode and one (35 s) of the spray holes which is located closest to the spark gap.

5. The ignition system as set forth in claim 1, wherein a relation of 0.3≤S/V≤2.1 is met where V is a volume of the pre-chamber in units of cubic centimeter, and S is a total sectional area of the spray hole in the dividing wall in units of mm\hat{ }2.

6. The ignition system as set forth in claim 1, wherein an in-gap gas flow turns from a spray hole opposite direction side to a spray hole direction side until the ignition timing is reached in the after-top-dead-center ignition control mode to have the in-gap gas flow oriented to the spray hole direction side at the ignition timing where the spray hole direction side represents a direction which includes, as a component, a spray hole direction that is a direction oriented from the first electrode to the spray hole, the spray hole opposite direction side represents a direction which includes, as a component, a spray hole opposite direction oriented opposite to the spray hole direction, or when the dividing wall has a plurality of spray holes, the spray hole direction is a direction oriented from the first electrode to one (35 s) of the spray holes which is located closest to the first electrode, and the in-gap gas flow denotes a flow of gas in the spark gap.
